(19) United States
(12) Patent Application Publication
(10) Pub. No.: US 2011/0009515 A1
(43) Pub. Date: Jan. 13, 2011

(54) STORAGE AND TRANSPORTATION STABLE POLYOL BLENDS OF NATURAL OIL BASED POLYOLS AND AMINE INITIATED POLYOLS

(75) Inventor: Francois M. Casati, Pfaffikon (CH)

Correspondence Address: The Dow Chemical Company, P.O. BOX 1967, 2040 Dow Center, Midland, MI, 48641, US

(73) Assignee: DOW GLOBAL TECHNOLOGIES INC., Midland, MI (US)

(21) Appl. No.: 12/919,497

(22) PCT Filed: Feb. 24, 2009
(86) PCT No.: PCT/US2009/034972

§ 371 Date: Aug. 26, 2010

Related U.S. Application Data
(60) Provisional application No. 61/032,554, filed on Feb. 29, 2008.

(51) Int. Cl. C08J 9/00; C09K 3/00

(52) U.S. Cl. 521/170; 252/182.24

(57) ABSTRACT

A storage and shipping stable polyol blend is provided, The polyol blend includes a first and second polyol. The first polyol may be derived from a natural oil, and the second polyol, may be an amine initiated conventional petroleum-based polyol. The mixture of the first and second polyols form a polyol blend having a single continuous phase.

### CROSS-REFERENCE TO RELATED APPLICATIONS

This application claims benefit of U.S. Provisional Patent Application Ser. No. 61/032,554, filed Feb. 29, 2008, entitled “STORAGE AND TRANSPORTATION STABLE POLYOL BLENDS OF NATURAL OIL BASED POLYOLS AND AMINE INITIATED POLYOLS” which is herein incorporated by reference.

### BACKGROUND

1. Field of the Invention

Embodiments of the present invention generally relate to blends of polyols; more specifically, to blends of polyols based on renewable resources and amine initiated polyols.

2. Description of the Related Art

Polyether polyols based on the polymerization of alkylene oxides, polyester polyols, or combinations thereof, are together with isocyanates the major components of a polyurethane system. One class of polyols are conventional petroleum-based polyols, and another class are those polyols made from vegetable oils or other renewable feedstocks. Polyols based on renewable feedstocks may be sold and marketed as a component of polyol blends which often also may include conventional petroleum-based polyols. However, polyols made from renewable feedstocks may not be miscible or otherwise compatible with conventional petroleum-based polyols, such that upon storage and transportation of the polyol blends, the blends may form separate and immiscible layers.

Additionally, a number of materials and additives may be added to the polyol blends used in producing polyurethane products. These materials and additives, such as amine catalysts, may be released as volatile organic compounds (VOCs) from the finished polyurethane product.

Therefore, there is a need for a stable polyol blend which can be used for the production of polyurethane foams that result in a decreased amount of VOCs and an increased amount of renewable resources in the final polyurethane product.

### SUMMARY

The embodiments of the present invention provide flexible polyurethane foams made by using natural oil-based polyols while at the same time limit the amount of VOCs in the flexible polyurethane foam.

In one embodiment of the invention, a storage and shipping stable polyol blend is provided. The polyol blend includes a first polyol and a second polyol. The first polyol is derived from a natural oil, has a hydroxyl number of about 300 or below, and a viscosity at 25° C. of about 6000 mPa·s or below. The second polyol is an amine initiated conventional petroleum-based polyol having a nominal starter functionality of between about 2 and about 8 and a hydroxyl number of between about 15 and about 200. The first and second polyols form a polyol blend having a single continuous phase.

In another embodiment, a flexible polyurethane foam is provided. The flexible polyurethane foam includes the reaction product of an isocyanate and a polymer polyol dispersion. The polymer polyol dispersion includes the polyol blend of the first and second polyols listed above, a third polyol, and a particle population. The third polyol is not amine initiated and has a nominal starter functionality of between about 2 and about 8 and a hydroxyl number of between about 15 and about 200. The particle population includes at least one of acrylonitrile, polystyrene, methacrylonitrile, methyl methacrylate, or styrene-acrylonitrile particles. The particle population is dispersed in the first, second, and third polyol.

### DETAILED DESCRIPTION

Embodiments of the present invention provide for storage stable and transportation stable polyol blends of at least one natural oil based polyols and at least one amine initiated polyols, and the use of these blends in making polyurethane foams having a high content of renewable resources and a low content of VOCs. Polyols are compounds that have at least one group containing an active hydrogen atom capable of undergoing reaction with an isocyanate. Preferred among such compounds are materials having at least two hydroxyls, primary or secondary, or at least two amines, primary or secondary, carboxylic acid, or thiol groups per molecule. Compounds having at least two hydroxyl groups or at least two amine groups per molecule are especially preferred due to their desirable reactivity with polyisocyanates.

The natural oil derived polyols are polyols based on or derived from renewable feedstock resources such as natural and/or genetically modified (GMO) plant vegetable seed oils and/or animal source fats. Such oils and/or fats are generally comprised of triglycerides, that is, fatty acids linked together with glycerol. Preferred are vegetable oils that have at least about 70 percent unsaturated fatty acids in the triglyceride. Preferably the natural product contains at least about 85 percent by weight unsaturated fatty acids. Examples of preferred vegetable oils include, for example, those from castor, soybean, olive, peanut, rapeseed, corn, sesame, cotton, canola, safflower, linseed, palm, sunflower, jatropha seed oils, or a combination thereof. Additionally, non human food chain organisms such as algae may also be used. Examples of animal products include lard, beef tallow, fish oils and mixtures thereof. A combination of vegetable and animal based oils/fats may also be used.

For use in the production of polyurethane foams, the natural material may be modified to give the material isocyanate reactive groups or to increase the number of isocyanate reactive groups on the material. Preferably such reactive groups are a hydroxyl group. Several chemistries can be used to prepare the natural oil derived polyols. Such modifications of a renewable resource include, for example, epoxidation, hydroxylation, ozonolysis, esterification, hydroformylation, or alkoxylation. Such modifications are commonly known in the art and are described, for example, in U.S. Pat. Nos. 4,534,907, 4,640,801, 6,107,433, 6,121,398, 6,897,283, 6,891,053, 6,962,636, 6,979,477, and PCT publication Nos. WO 2004/020497, WO 2004/096744, and WO 2004/096882.

After the production of such polyols by modification of the natural oils, the modified products may be further alkoxylated. The use of ethylene oxide (EO) or mixtures of EO with other oxides, introduce hydrophilic moieties into the polyol. In one embodiment, the modified product undergoes alkoxylation with sufficient EO to produce a natural oil derived polyol with between about 10 weight % and about 60 weight % percent EO; preferably between about 20 weight % and about 40 weight % EO.

In another embodiment, the natural oil derived polyols are obtained by a multi-step process wherein the animal or vegetable oils/fats is subjected to transesterification and the constituent fatty acids recovered. This step is followed by hydroformylating carbon-carbon double bonds in the constituent fatty acids to form hydroxymethyl groups, and then forming a polyester or polyether/polyester by reaction of the hydroxymethylated fatty acid with an appropriate initiator compound. Such a multi-step process is commonly known in the art, and is described, for example, in PCT publication Nos. WO 2004/096882 and 2004/096883. The multi-step process results in the production of a polyol with both hydrophobic and hydrophilic moieties, which results in enhanced miscibility with both water and conventional petroleum-based polyols.

The initiator for use in the multi-step process for the production of the natural oil derived polyols may be any initiator used in the production of conventional petroleum-based polyols. Preferably the initiator is selected from the group consisting of neopentylglycol; 1,2-propylene glycol; trimethylolpropane; pentaerythritol; sorbitol; sucrose; glycerol; diethanolamine; alkanediols such as 1,6-hexanediol, 1,4-butanediol; 1,4-cyclohexane diol; 2,5-hexanediol; ethylene glycol; diethylene glycol, triethylene glycol; bis-3-aminopropyl methylamine; ethylene diamine; diethylene triamine; 9(1)-hydroxymethyloctadecanol, 1,4-bishydroxymethylcyclohexane; 8,8-bis(hydroxymethyl)tricyclo[5,2,1,0^{2,6}]decene; Dimerol alcohol (36 carbon diol available from Henkel Corporation); hydrogenated bisphenol; 9,9(10,10)-bishydroxymethyloctadecanol; 1,2,6-hexanetriol and combination thereof. More preferably the initiator is selected from the group consisting of glycerol; ethylene glycol; 1,2-propylene glycol; trimethylolpropane; ethylene diamine; pentaerythritol; diethylene triamine; sorbitol; sucrose; or any of the aforementioned where at least one of the alcohol or amine groups present therein has been reacted with ethylene oxide, propylene oxide or mixture thereof; and combination thereof. More preferably, the initiator is glycerol, trimethylopropane, pentaerythritol, sucrose, sorbitol, and/or mixture thereof.

In one embodiment, the initiators are alkoxlyated with ethylene oxide or a mixture of ethylene and at least one other alkylene oxide to give an alkoxylated initiator with a molecular weight between about 200 and about 6000, preferably between about 500 and about 3000.

The functionality of the at least one natural oil derived polyol, is above about 1.5 and generally not higher than about 6. In one embodiment, the functionality is below about 4. The hydroxyl number of the at least one natural oil derived polyol is below about 300 mg KOH/g, preferably between about 50 and about 300, more preferably between about 60 and about 200. In one embodiment, the hydroxyl number is below about 100.

The level of renewable feedstock in the natural oil derived polyol can vary between about 10 and about 100%, usually between about 10 and about 90%.

The natural oil derived polyols may constitute up to about 90 weight % of the polyol blend. However, in a flexible foam, the natural oil derived polyol may often constitute at least 5 weight %, at least 10 weight %, at least 25 weight %, at least 35 weight %, at least 40 weight %, at least 50 weight %, or at least 55 weight % of the total weight of the polyol blend. The natural oil derived polyols may constitute 40% or more, 50 weight % or more, 60 weight % or more, 75 weight % or more, 85 weight % or more, 90 weight % or more, or 95 weight % or more of the total weight of the combined polyols.

Combination of two types or more of natural oil derived polyols may also be used, either to maximize the level of seed oil in the foam formulation, or to optimize foam processing and/or specific foam characteristics, such as resistance to humid aging.

The viscosity measured at 25° C. of the natural oil derived polyols is generally less than about 6,000 mPa·s. Preferably, the viscosity is less than about 5,000 mPa·s.

In addition to the natural oil based polyols described above, the polyol blend includes an amine initiated polyol, i.e. a polyol made from the alkoxylation of a primary or secondary amine, or, optionally from an aminoalcohol. Such amine initiated polyols have inherent autocatalytic activity and can replace a portion or all of the amine catalyst generally used in the production of flexible polyurethane foams. The amine initiated polyols may be made from an initiator containing a tertiary amine, polyols containing a tertiary amine group in the polyol chain or a polyol partially capped with a tertiary amine group. The amine initiated polyol may be added to replace at least 20 percent by weight of conventional amine catalyst while maintaining the same reaction profile for making polyurethane foams. More preferably the amine initiated polyol may be added to replace at least 30 percent by weight of the amine catalyst while maintaining the same reaction profile. Such amine initiated polyols may also be added to replace at least 50 percent by weight of the amine catalyst while maintaining the same reaction profile. Alternatively, such amine initiated polyols may be added to enhance the demold time.

In one embodiment, the amine initiated polyol has a weight average molecular weight between about 1000 and about 12,000 and is prepared by alkoxylation of at least one initiator molecule of the formula

HₘA—(CH₂)ₙ—N(R)—(CH₂)ₚ—AHₘ (I)

wherein n and p are independently integers from 2 to 6,

A at each occurrence is independently oxygen, nitrogen, sulfur or hydrogen, with the proviso that only one of A can be hydrogen at one time,

R is a C₁ to C₃ alkyl group,

m is equal to 0 when A is hydrogen, is 1 when A is oxygen and is 2 when A is nitrogen, or

H₂N—(CH₂)_{q}—N—(R)—H (II)

where q is an integer from 2 to 12 and

R is a C₁ to C₃ alkyl group.

In various embodiments of the invention, the initiators for the production of the amine initiated polyols include, 3,3′-diamino-N-methyldipropylamine, 2,2′-diamino-N-methyldiethylamine, 2,3-diamino-N-methyl-ethyl-propylamine N-methyl-1,2-ethanediamine and N-methyl-1,3-propanediamine.

Other initiators include linear and cyclic compounds containing an amine. Exemplary polyamine initiators include ethylene diamine, neopentyldiamine, 1,6-diaminohexane; bisaminomethyltricyclodecane; bisaminocyclohexane; diethylene triamine; bis-3-aminopropyl methylamine; triethylene tetramine various isomers of toluene diamine; diphenylmethane diamine; N-methyl-1,2-ethanediamine, N-Methyl-1,3-propanediamine, N,N-dimethyl-1,3-diaminopropane, N,N-dimethylethanolamine, 3,3′-diamino-N-methyldipropylamine, N,N-dimethyldipropylenetriamine, aminopropylimidazole.

Exemplary amino alcohol s include ethanolamine, diethanolamine, and triethanolamine.

The amine initiated polyol can also contain a tertiary nitrogen in the chain, by using for example an alkyl-aziridine as co-monomer with PO and EO.

Polyols with tertiary amine end-cappings are those which contain a tertiary amino group linked to at least one tip of a polyol chain. These tertiary amines can be N,N-dialkylamino, N-alkyl, aliphatic or cyclic, amines, polyamines.

The amine initiated polyols may constitute up to about 50 weight percent of the total polyol, preferably up to about 30 weight percent of the polyol. The amine initiated polyols may constitute at least about 1 weight percent of the polyol, preferably, at least about 5 weight percent, more preferably, at least about 10 weight percent or greater of the total polyol.

Surprisingly, it has been found that, when combined, the amine initiated polyols and natural oil derived polyols will form a mixture having one phase. In other words, the amine initiated polyols and natural oil derived polyols are miscible and otherwise compatible with each other. The natural oil derived polyols and amine initiated polyols are miscible with each other at least when the natural oil derived polyol is present at a ratio of at least about 40 weight % of the total weight of the natural oil derived polyol and the amine initiated polyol, preferably, at least about 50 weight %, more preferably, at least about 55 weight %, more preferably, at least about 60 weight %, at least about 65 weight %, or more preferably, at least about 70 weight %.

The polyol blend may also not exhibit phase separation even after exposure to temperatures above ambient room temperature. For example, the polyol blend remains a one phase mixture after temperatures of above about 40° C., above about 50° C., or above about 60° C.

The polyol blend may also not exhibit phase separation after exposure to temperatures below ambient room temperature. For example, the polyol blend remains a one phase mixture after temperatures of below about 20° C., below about 10° C., below about 5° C., or below about 0° C.

Additionally, the polyol blend may also not exhibit phase separation even after a prolonged storage time period. For example, the polyol blend remains a one phase mixture after about 1 day, above about 2 days, above about 3 days, above about 4 days, above about 5 days, above about 10 days, above about 20 days, above about 30 days, or above about 40 days at room temperature.

Because polyol blends may be shipped and transported in rail cars, in drums, on trucks, on ships, or the like, the polyol blends may be exposed to extreme temperatures and conditions over prolonged times. The polyol blend's ability to not exhibit any phase separation under such conditions increases the uniformity of the polyurethane products formed by reacting the polyol blend with the isocyanates.

Some natural oil derived polyols may be intrinsically hazy or cloudy based on visual observations. However, by blending them with an amine initiated polyol, at a proper ratio, a clear solution, based on visual observations, is obtained. Preferably, the natural oil derived polyol is present at a ratio of at least about 50 weight % of the total weight of the natural oil derived polyol and the amine initiated polyol, preferably, at least about 55 weight %, more preferably, at least about 60 weight %, more preferably, at least about 65 weight %, and more preferably, at least about 70 weight %. A clear colorless liquid is an indication that the one phase polyol blend is a homogenous mixture of the natural oil derived polyol and the amine initiated polyol.

The polyol blend may optionally include a third polyol, which includes at least one conventional petroleum-based polyol. The at least one conventional petroleum-based polyol includes materials having at least one group containing an active hydrogen atom capable of undergoing reaction with an isocyanate, and not having parts of the material derived from a vegetable or animal oil. Suitable conventional petroleum-based polyols are well known in the art and include those described herein and any other commercially available polyol. Mixtures of one or more polyols and/or one or more polymer polyols may also be used to produce polyurethane products according to embodiments of the present invention.

Representative polyols include polyether polyols, polyester polyols, polyhydroxy-terminated acetal resins, hydroxyl-terminated amines and polyamines. Alternative polyols that may be used include polyalkylene carbonate-based polyols and polyphosphate-based polyols. Preferred are polyols prepared by adding an alkylene oxide, such as ethylene oxide, propylene oxide, butylene oxide or a combination thereof, to an initiator having from 2 to 8, preferably 2 to 6 active hydrogen atoms. Catalysis for this polymerization can be either anionic or cationic, with catalysts such as KOH, CsOH, boron trifluoride, or a double cyanide complex (DMC) catalyst such as zinc hexacyanocobaltate or quaternary phosphazenium compound.

Examples of suitable initiator molecules are water, organic dicarboxylic acids, such as succinic acid, adipic acid, phthalic acid and terephthalic acid; and polyhydric, in particular dihydric to octohydric alcohols or dialkylene glycols.

Exemplary polyol initiators include, for example, ethanediol, 1,2- and 1,3-propanediol, diethylene glycol, dipropylene glycol, 1,4-butanediol, 1,6-hexanediol, glycerol, pentaerythritol, sorbitol, sucrose, neopentylglycol; 1,2-propylene glycol; trimethylolpropane glycerol; 1,6-hexanediol; 2,5-hexanediol; 1,4-butanediol; 1,4-cyclohexane diol; ethylene glycol; diethylene glycol; triethylene glycol; 9(1)-hydroxymethyloctadecanol, 1,4-bishydroxymethylcyclohexane; 8,8-bis(hydroxymethyl)tricyclo[5,2,1,0^{2,6}]decene; Dimerol alcohol; hydrogenated bisphenol; 9,9(10,10)-bishydroxymethyloctadecanol; 1,2,6-hexanetriol; and combination thereof.

The conventional petroleum-based polyols may for example be poly(propylene oxide) homopolymers, random copolymers of propylene oxide and ethylene oxide in which the poly(ethylene oxide) content is, for example, from about 1 to about 30% by weight, ethylene oxide-capped poly(propylene oxide) polymers and ethylene oxide-capped random copolymers of propylene oxide and ethylene oxide. For slabstock foam applications, such polyethers preferably contain 2-5, especially 2-4, and preferably from 2-3, mainly secondary hydroxyl groups per molecule and have an equivalent weight per hydroxyl group of from about 400 to about 3000, especially from about 800 to about 1750. For high resiliency slabstock and molded foam applications, such polyethers preferably contain 2-6, especially 2-4, mainly primary hydroxyl groups per molecule and have an equivalent weight per hydroxyl group of from about 1000 to about 3000, especially from about 1200 to about 2000. When blends of polyols are used, the nominal average functionality (number of hydroxyl groups per molecule) will be preferably in the ranges specified above. For viscoelastic foams shorter chain polyols with hydroxyl numbers above 150 are also used. For the production of semi-rigid foams, it is preferred to use a trifunctional polyol with a hydroxyl number of 30 to 80.

The polyether polyols may contain low terminal unsaturation (for example, less that 0.02 meq/g or less than 0.01 meq/g), such as those made using so-called double metal cyanide (DMC) catalysts. Polyester polyols typically contain about 2 hydroxyl groups per molecule and have an equivalent weight per hydroxyl group of about 400-1500.

The conventional petroleum-based polyols may be a polymer polyol. In a polymer polyol, polymer particles are dispersed in the conventional petroleum-based polyol. Such particles are widely known in the art an include styrene-acrylonitrile (SAN), acrylonitrile (ACN), polystyrene (PS), methacrylonitrile (MAN), or methyl methacrylate (MMA) particles. In one embodiment the polymer particles are SAN particles.

The conventional petroleum-based polyols may constitute up to about 10 weight %, 20 weight %, 30 weight %, 40 weight %, 50 weight %, or 60 weight % of polyol formulation. The conventional petroleum-based polyols may constitute at least about 1 weight %, 5 weight %, 10 weight %, 20 weight %, 30 weight %, or 50 weight % of polyol formulation. The enhanced miscibility observed between the amine initiated polyols and natural oil derived polyols may also enhance the miscibility between the natural oil derived polyols and the conventional petroleum-based polyols. Thus, a polyol blend including natural oil derived polyols, natural oil derived polyols, and conventional petroleum-based polyols will form a homogeneous mixture.

In addition to the above described polyols, the polyol blend may also include other ingredients such as catalysts, silicone surfactants, preservatives, and antioxidants,

The polyol blend may be used in the production of polyurethane products, such as polyurethane foams, elastomers, microcellular foams, adhesives, coatings, etc. For example, the polyol blend may be used in a formulation for the production of flexible polyurethane foam. For the production of a polyurethane foam the polyol blend may be combined with additional ingredients such as catalysts, crosslinkers, emulsifiers, silicone surfactants, preservatives, flame retardants, colorants, antioxidants, reinforcing agents, fillers, including recycled polyurethane foam in form of powder.

Although the amine initiated polyols according to embodiments of the invention may reduce or eliminate the need for additional catalyst, a lesser amount of catalysts may be provided in some embodiments to maintain an adequate reaction profile of the polyol-isocyanate reaction. Any suitable urethane catalyst may be used, including tertiary amine compounds, amines with isocyanate reactive groups and organometallic compounds. Exemplary tertiary amine compounds include triethylenediamine, N-methylmorpholine, N,N-dimethylcyclohexylamine, pentamethyldiethylenetriamine, tetramethylethylenediamine, bis(dimethylaminoethyl)ether, 1-methyl-4-dimethylaminoethylpiperazine, 3-methoxy-N-dimethylpropylamine, N-ethylmorpholine, dimethylethanolamine, N-cocomorpholine, N,N-dimethyl-N′,N′-dimethyl isopropylpropylenediamine, N,N-diethyl-3-diethylamino-propylamine and dimethylbenzylamine. Exemplary organometallic catalysts include organomercury, organolead, organoferric and organotin catalysts, with organotin catalysts being preferred among these. Suitable tin catalysts include stannous chloride, tin salts of carboxylic acids such as dibutyltin di-laurate. A catalyst for the trimerization of isocyanates, resulting in a isocyanurate, such as an alkali metal alkoxide may also optionally be employed herein. The amount of amine catalysts can vary from 0 to about 5 percent in the formulation or organometallic catalysts from about 0.001 to about 1 percent in the formulation can be used.

One or more crosslinkers may be provided, in addition to the polyols described above. This is particularly the case when making high resilience slabstock or molded foam. If used, suitable amounts of crosslinkers are from about 0.1 to about 1 part by weight, especially from about 0.25 to about 0.5 part by weight, per 100 parts by weight of polyols.

The crosslinkers may have three or more isocyanate-reactive groups per molecule and an equivalent weight per isocyanate-reactive group of less than 400. The crosslinkers preferably may include from 3-8, especially from 3-4 hydroxyl, primary amine or secondary amine groups per molecule and have an equivalent weight of from 30 to about 200, especially from 50-125. Examples of suitable crosslinkers include diethanol amine, monoethanol amine, triethanol amine, mono- di- or tri(isopropanol) amine, glycerine, trimethylol propane, pentaerythritol, and sorbitol.

It is also possible to use one or more chain extenders in the foam formulation. The chain extender may have two isocyanate-reactive groups per molecule and an equivalent weight per isocyanate-reactive group of less than 400, especially from 31-125. The isocyanate reactive groups are preferably hydroxyl, primary aliphatic or aromatic amine or secondary aliphatic or aromatic amine groups. Representative chain extenders include amines ethylene glycol, diethylene glycol, 1,2-propylene glycol, dipropylene glycol, tripropylene glycol, ethylene diamine, phenylene diamine, bis(3-chloro-4-aminophenyl)methane and 2,4-diamino-3,5-diethyl toluene. If used, chain extenders are typically present in an amount from about 1 to about 50, especially about 3 to about 25 parts by weight per 100 parts by weight high equivalent weight polyol.

A polyether polyol may also be included in the formulation, i.e, as part of the at least one conventional petroleum-based polyol, to promote the formation of an open-celled or softened polyurethane foam. Such cell openers generally have a functionality of 2 to 12, preferably 3 to 8, and a molecular weight of at least 5,000 up to about 100,000. Such polyether polyols contains at least 50 weight percent oxyethylene units, and sufficient oxypropylene units to render it compatible with the components. The cell openers, when used, are generally present in an amount from 0.2 to 5, preferably from 0.2 to 3 parts by weight of the total polyol. Examples of commercially available cell openers are VORANOL Polyol CP 1421 and VORANOL Polyol 4053; VORANOL is a trademark of The Dow Chemical Company.

The formulations may then be reacted with, at least one isocyanate to form a flexible polyurethane foam. Isocyanates which may be used in the present invention include aliphatic, cycloaliphatic, arylaliphatic and aromatic isocyanates.

Examples of suitable aromatic isocyanates include the 4,4′-, 2,4′ and 2,2′-isomers of diphenylmethane diisocyante (MDI), blends thereof and polymeric and monomeric MDI blends, toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′-dimehtyldiphenyl, 3-methyldiphenyl-methane-4,4′-diisocyanate and diphenyletherdiisocyanate and 2,4,6-triisocyanatotoluene and 2,4,4′-triisocyanatodiphenylether.

Mixtures of isocyanates may be used, such as the commercially available mixtures of 2,4- and 2,6-isomers of toluene diisocyantes. A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. TDI/MDI blends may also be used.

Examples of aliphatic polyisocyanates include ethylene diisocyanate, 1,6-hexamethylene diisocyanate, isophorone diisocyanate, cyclohexane 1,4-diisocyanate, 4,4′-dicyclohexylmethane diisocyanate, saturated analogues of the above mentioned aromatic isocyanates and mixtures thereof.

The at least one isocyanate is added to the blend for an isocyanate index of between about 30 and about 150, preferably between about 50 and about 120, more preferably between about 60 and about 110. The isocyanate index is the ratio of isocyanate-groups over isocyanate-reactive hydrogen atoms present in a formulation, given as a percentage. Thus, the isocyanate index expresses the percentage of isocyanate actually used in a formulation with respect to the amount of isocyanate theoretically required for reacting with the amount of isocyanate-reactive hydrogen used in a formulation.

For the production of flexible foams, the polyisocyanates may often be the toluene-2,4- and 2,6-diisocyanates or MDI or combinations of TDI/MDI or prepolymers made therefrom.

Isocyanate tipped prepolymer may also be used in the polyurethane formulation. Such prepolymers are obtained by the reaction of an excess of polyol. The polyol may be the conventional petroleum-based polyol, the natural oil derived polyol, the amine initiated polyol, and/or a combination of the polyols.

Processing for producing polyurethane products are well known in the art. In general components of the polyurethane-forming reaction mixture may be mixed together in any convenient manner, for example by using any of the mixing equipment described in the prior art for the purpose such as described in “Polyurethane Handbook”, by G. Oertel, Hanser publisher.

In general, the polyurethane foam is prepared by mixing the polyisocyanate of and polyol composition in the presence of the blowing agent, catalyst(s) and other optional ingredients as desired under conditions such that the polyisocyanate and polyol composition react to form a polyurethane and/or polyurea polymer while the blowing agent generates a gas that expands the reacting mixture. The foam may be formed by the so-called prepolymer method, in which a stoichiometric excess of the polyisocyanate is first reacted with the high equivalent weight polyol(s) to form a prepolymer, which is in a second step reacted with a chain extender and/or water to form the desired foam. Frothing methods are also suitable. So-called one-shot methods may be preferred. In such one-shot methods, the polyisocyanate and all polyisocyanate-reactive are simultaneously brought together and caused to react. Three widely used one-shot methods which are suitable for use in this invention include slabstock foam processes, high resiliency slabstock foam processes, and molded foam methods.

Slabstock foam is conveniently prepared by mixing the foam ingredients and dispensing them into a trough or other region where the reaction mixture reacts, rises freely against the atmosphere (sometimes under a film or other flexible covering) and cures. In common commercial scale slabstock foam production, the foam ingredients (or various mixtures thereof) are pumped independently to a mixing head where they are mixed and dispensed onto a conveyor that is lined with paper or plastic. Foaming and curing occurs on the conveyor to form a foam bun. The resulting foams are typically from about from about 10 kg/m³ to 80 kg/m³, especially from about 15 kg/m³ to 60 kg/m³, preferably from about 17 kg/m³ to 50 kg/m³ in density.

A preferred slabstock foam formulation contains from about 3 to about 6, preferably about 4 to about 5 parts by weight water are used per 100 parts by weight high equivalent weight polyol at atmospheric pressure. At reduced pressure these levels are reduced.

High resilience slabstock (HR slabstock) foam is made in methods similar to those used to make conventional slabstock foam but using higher equivalent weight polyols. HR slabstock foams are characterized in exhibiting a Ball rebound score of 45% or higher, per ASTM 3574.03. Water levels tend to be from about 2 to about 6, especially from about 3 to about 5 parts per 100 parts (high equivalent) by weight of polyols.

Molded foam can be made according to the invention by transferring the reactants (polyol composition including copolyester, polyisocyanate, blowing agent, and surfactant) to a closed mold where the foaming reaction takes place to produce a shaped foam. Either a so-called “cold-molding” process, in which the mold is not preheated significantly above ambient temperatures, or a “hot-molding” process, in which the mold is heated to drive the cure, can be used. Cold-molding processes are preferred to produce high resilience molded foam. Densities for molded foams generally range from 30 to 50 kg/m³.

### EXAMPLES

The following examples are provided to illustrate the embodiments of the invention, but are not intended to limit the scope thereof. All parts and percentages are by weight unless otherwise indicated.

The Following Materials were Used:
Diethanolamine: Available from the Sigma-Aldrich Co.
DABCO 33LV: A 33% solution of triethylenediamine in propylene glycol available from Air Products & Chemicals Inc.
NIAX A-1: A tertiary amine catalyst available from Momentive Performance Materials.
NIAX A-300: A tertiary amine catalyst available from Momentive Performance Materials.
TEGOSTAB B 8715LF: A silicone-based surfactant available from Degussa-Goldschmidt Corporation.
SPECFLEX* NC 632: A 1,700 equivalent weight polyoxypropylene polyoxyethylene polyol initiated with a blend of glycerol and sorbitol. Available from The Dow Chemical Company.
SPECFLEX* NC 700: A grafted polyether polyol containing 40% copolymerized styrene and acrylonitrile (SAN). Available from The Dow Chemical Company.
VORANOL* RA 450 A 125 equivalent weight propoxylated tetrol initiated with ethylenediamine. Available from The Dow Chemical Company.
Polyol A A 1,700 equivalent weight propoxylated tetrol initiated with 3,3′-diamino-N-methyl-dipropylamine and capped with 18% Ethylene oxide
Polyol B A 1,700 equivalent weight propoxylated tetrol initiated with 3,3′-diamino-N-methyl-dipropylamine and capped with 15% Ethylene oxide
VORANATE* T-80: A toluene diisocyanate composition (80/20 ratio of 2,4 and 2,6-isomers) available from The Dow Chemical Company.
NOBP A: Soybean oil based polyol prepared according to examples 19-22 of WO 2004/096882 having an OH number of 89.
NOBP B: Hydroxymethylated methyl ester monomers of soybean oil having a molecular weight of about 328 g/mol prepared according to WO 2004/096744.
NOBP C: A soybean oil based polyol available from Cargill under the name BiOH™
*SPECFLEX, VORANOL, and VORANATE are trademarks of The Dow Chemical Company

### Examples 1-8 and Comparative Examples 1 and 2

A comparison of the miscibility of various polyol compositions at room temperature is performed. The polyol blends are stirred at 2,000 RPM for 5 minutes, then stored in glass bottles for degassing. The visual observations after 40 days of storage at room temperature are reported in table 1:

TABLE 1

| | E1 | E2 | E3 | E4 | E5 | E6 | E7 | E8 | C1 | C2 |
|---|---|---|---|---|---|---|---|---|---|---|
| Polyol A | 30 | 20 | 70 | | 30 | | 30 | 70 | | |
| Polyol B | | | | 30 | | | | | | |
| NOBP A | 70 | 80 | 30 | 70 | | | | | 70 | |
| NOBP B | | | | | 70 | 70 | | | | 70 |
| NOBP C | | | | | | | 70 | 30 | | |
| Voranol | | | | | | 30 | | | | |
| RA 450 | | | | | | | | | | |
| Specflex | | | | | | | | | 30 | 30 |
| NC 632 | | | | | | | | | | |
| Observation | Clear, | Clear, | Cloudy, | Clear, | Cloudy, | Cloudy, | Clear, | Cloudy, | | |
| | 1 | 1 | 1 | 1 | 1 | 1 | 1 | 1 | 2 | 2 |
| | phase | phase | phase | phase | phase | phase | phase | phase | phases | phases |

In both comparative examples C1 and C2 the bottom layer contains a waxy phase. However, examples E1-E8 demonstrate that NOBP's and amine initiated polyols are miscible, albeit with cloudiness in case of NOBP B which does not contain ethylene oxide moieties. Specflex NC 632, which is a conventional EO capped polyol, is not miscible with NOBP A or with NOBP B. Surprisingly; the amine initiated polyols resolve this miscibility issue to produce 1 phase polyol blends. Examples 7 and 8, based on NOBP C, a natural oil derived polyol made from a different process than NOBP A, give the same type of compatibility with polyol A as does NOBP A.

### Example 9 and Comparative Example 3

Foams (example E9 and comparative example C3) are made in the laboratory by preblending the components, except for the isocyanate, of Table 2, all conditioned at 25° C. The isocyanate separately is also conditioned at 25° C. Machine made foam is produced using a high pressure impingement mix-head equipped KM-40 from Krauss-Maffei into a 400×400×70 mm aluminium mold, heated at 60° C., equipped with vent-holes. The mold release agent is Kluber 41-2038, available from Chem-Trend.

TABLE 2

| | E9 | C3 |
|---|---|---|
| Polyol Blend E1 | 42.9 | 0 |
| Specflex NC 700 | 10 | 10 |
| Specflex NC 632 | 47.1 | 60 |
| NOBP A | | 30 |
| Water | 4.1 | 4.1 |
| DEOA | 0.7 | 0.7 |
| Niax A-1 | 0 | 0.05 |
| Dabco 33 LV | 0.30 | 0.30 |
| Niax A-300 | 0.1 | 0.1 |
| Tegostab B8715LF | 0.8 | 0.8 |
| Voranate T-80 index | 90 | 90 |
| Core density (kg/m3) | 37.9 | 34.5 |
| Airflow (cfm) | 1.9 | 1.3 |
| 75% Compression set (%) | 12.7 | 13.6 |

Example E9 shows that the introduction of the polyol blend El allows the elimination of Niax A-1, a fugitive amine catalyst generator of VOC, while foam properties are maintained as shown by comparative example C3. Indeed a demolding time of 5 minutes is obtained for both formulations. Therefore, the polyol blends of the embodiments of this invention help lower the polyurethane foam's volative organic content.

While the foregoing is directed to embodiments of the present invention, other and further embodiments of the invention may be devised without departing from the basic scope thereof, and the scope thereof is determined by the claims that follow.

1. A storage and shipping stable polyol blend, comprising:
a first polyol having a hydroxyl number of about 300 or below, and a viscosity at 25° C. of about 6000 mPa·s or below, wherein the first polyol is derived from a natural oil, and
a second polyol, wherein the second polyol is an amine initiated conventional petroleum-based polyol having a nominal starter functionality of between about 2 and about 8 and a hydroxyl number of between about 15 and about 200, and wherein the first and second polyols form a polyol blend having a single continuous phase.

2. The polyol blend of claim 1, wherein the first polyol is present at a ratio of at least about 40 weight % of the total weight of the first and second polyols.

3. The polyol blend of claim 2, wherein the first polyol is present at a ratio of at least about 50 weight % of the total weight of the first and second polyols.

4. The polyol blend of claim 3, wherein the first polyol is present at a ratio of at least about 70 weight % of the total weight of the first and second polyols.

5. The polyol blend of claim 1, wherein the polyol blend further comprises a third polyol having a nominal starter functionality of between about 2 and about 8 and a hydroxyl number of between about 15 and about 200, wherein the third polyol is not amine initiated.

6. The polyol blend of claim 1, wherein the blend is a clear and colorless homogenous mixture.

7. The polyol blend of claim 1, wherein the single continuous phase does not exhibit phase separation upon 1 day of storage.

8. The polyol blend of claim 7, wherein the single continuous phase does not exhibit phase separation upon 10 days of storage.

9. The polyol blend of claim 8, wherein the single continuous phase does not exhibit phase separation upon 20 days of storage.

10. The polyol blend of claim 9, wherein the single continuous phase does not exhibit phase separation upon 40 days of storage.

11. The polyol blend of claim 9, wherein the single continuous phase does not exhibit phase separation upon having been exposed to temperatures of about 50° C.

12. The polyol blend of claim 11, wherein the single continuous phase does not exhibit phase separation upon having been exposed to temperatures of about 60° C.

13. The polyol blend of claim 1, wherein the amine initiated conventional petroleum-based polyol is made with an initiator comprising a tertiary amine group.

14. The polyol blend of claim 13, wherein the tertiary amine group comprises at least one of a methyl group, an ethyl group, or propyl group.

15. A flexible polyurethane foam, comprising:
a reaction product of
an isocyanate and
a polymer polyol dispersion comprising the polyol blend of claim 1 and a particle population comprising at least one of acrylonitrile, polystyrene, methacrylonitrile, methyl methacrylate, or styrene-acrylonitrile particles, wherein the particle population is dispersed in the polyol blend.
